(19) United States
(12) Patent Application Publication
(10) Pub. No.: US 2024/0154214 A1
(43) Pub. Date: May 9, 2024

(54) MULTI-LAYER CERAMIC BATTERY AND METHOD FOR MANUFACTURING THE SAME

(71) Applicant: SAMHWA CAPACITOR CO., LTD., Yongin-si (KR)

(72) Inventors: Young Joo OH, Yongin-si (KR); Jung Rag YOON, Yongin-si (KR); Jong Kyu LEE, Yongin-si (KR)

(21) Appl. No.: 18/323,800

(22) Filed: May 25, 2023

(30) Foreign Application Priority Data
Nov. 9, 2022 (KR) 10-2022-0148825

(51) Int. Cl. H01M 50/128; H01M 4/66; H01M 10/0562; H01M 10/0585; H01M 50/141; H01M 50/24

(52) U.S. Cl. CPC H01M 50/128; H01M 4/666; H01M 10/0562; H01M 10/0585; H01M 50/141; H01M 50/24; H01M 2300/0077

(57) ABSTRACT

Provided are a multi-layer ceramic battery (MLCB) and a method for manufacturing the same. The method for MLCB includes: forming a laminated body by laminating a first solid electrolyte layer interposed between a plurality of unit battery cells, respectively; forming an intermediate protective layer to cover a surface of the laminated body and to expose an end section of one side or the other side in the longitudinal direction of the laminated body; forming an outer protective layer to cover a surface of the intermediate protective layer and to expose the end section of one side or the other side in the longitudinal direction of the laminated body; and forming a pair of external electrodes to partially connect each end surface of the laminated body, respectively and to partially surround one side or the other side in the longitudinal direction of the laminated body.

### BACKGROUND OF THE INVENTION

### (A) Field of the Invention

The present invention relates to a multi-layer ceramic battery (MLCB) and a method for manufacturing the same, and more particularly, to prevent moisture from penetrating into the active material electrode layer due to thermal shock by forming a side protective layer along the active material electrode layer of a unit battery cell, thereby improving moisture permeation prevention.

### (B) Description of the Related Art

A solid state battery is formed by using a unit battery cell or a plurality of unit battery cells. Each of the unit battery cell or the plurality of unit battery cells is formed by sequentially arranging a cathode active material layer, an electrolyte layer, and an anode active material layer. The solid state battery uses a solid electrolyte layer as an electrolyte layer conducting lithium ions, and a technology related to a laminated solid secondary battery using a solid electrolyte layer as the electrolyte layer is known. The technology related to a laminated solid-state secondary battery using a solid-state electrolyte layer as an electrolyte layer is disclosed in Japan Patent Publication No. 2016-001601 (Patent Document 1).

Patent Document 1 relates to a solid battery and a battery pack using it. The body battery includes a capacitor having at least one storage element having a solid electrolyte layer between the first electrode layer and the second electrode layer. In addition, in a solid battery with a protective layer on the surface of a capacitor, the surface facing at least one of the solid batteries is formed so that the central thickness ratio of the solid battery to the end thickness of the solid battery is 0.65 or more and 0.95 or less. That is, the solid battery of Patent Document 1 improves moisture resistance by forming the thickness of the end thicker than the thickness of the center of the protective layer.

A conventional solid battery as disclosed in Patent Document 1, has a problem in that it is difficult to prevent moisture from penetrating into the cathode layer or the anode when a gap occurs between the protective layer and the external terminal due to thermal shock by forming a protective layer only on the outside of the unit cell.

### PRIOR DOCUMENTS

### Patent Documents

(Patent Document 1): Japan Patent Publication No. 2016-001601

### SUMMARY OF THE INVENTION

### Technical Problem

For solving the aforementioned problems, it is an object of the present invention to provide a multi-layer ceramic battery (MLCB) and a method for manufacturing the same, capable of improving moisture permeation prevention by preventing moisture from penetrating into the active material electrode layer due to thermal shock by forming a side protective layer along the active material electrode layer of a battery cell.

It is another object of the present invention to provide a multi-layer ceramic battery (MLCB) and a method for manufacturing the same, that can reduce thermal expansion with stable high-temperature properties and improve sealing properties by forming side protective layers using LAS-based ceramic materials and glass frit.

It is further another object of the present invention to provide a multi-layer ceramic battery (MLCB) and a method for manufacturing the same, capable of improving sealing characteristics to prevent moisture permeation by increasing adhesive force to a cathode layer or an anode layer during sintering by forming a side protective layer larger than a surface area of a unit battery cell.

### Technical Solution

In order to achieve the object of the present invention, there is provided a multi-layer ceramic battery (MLCB) that includes: a laminated body formed by laminating multiple unit battery cells with a first solid electrolyte layer interposed therebetween; an intermediate protective layer exposed to the end surface of one side or the other side in the longitudinal direction of the laminated body, and formed to cover a surface of the laminated body; an outer protective layer exposed to the end surface of one side or the other side in the longitudinal direction of the laminated body, and formed to cover a surface of the intermediate protective layer; and a pair of external electrodes partially surrounded one side or the other side in the longitudinal direction of the laminated body and partially connected each end surface of the laminated body,

Each of the multiple unit battery cells including: a first electrode layer connected to one of the pair of external electrodes on a surface of one side in the thickness direction of the second solid electrolyte layer, a first side protective layer formed to cover a side surface of the first electrode layer on one side in a thickness direction of the second solid electrolyte layer, a second electrode layer connected to the other one of the pair of external electrodes on a surface of the other side in the thickness direction of the second solid electrolyte layer and formed to alternate with the first electrode layer, a second side protective layer formed to cover the side surface of the second electrode layer on a surface of the other side in the thickness direction of the second solid electrolyte layer.

In order to achieve the object of the present invention, there is provided a method for manufacturing a multi-layer ceramic battery (MLCB) that the following steps includes: forming a laminated body by laminating a first solid electrolyte layer interposed between a plurality of unit battery cells, respectively; forming an intermediate protective layer to cover a surface of the laminated body and to expose an end section of one side or the other side in the longitudinal direction of the laminated body; forming an outer protective layer to cover a surface of the intermediate protective layer and to expose the end section of one side or the other side in the longitudinal direction of the laminated body; and forming a pair of external electrodes to partially connect each end surface of the laminated body, respectively and to partially surround one side or the other side in the longitudinal direction of the laminated body;
wherein the step of forming the laminated body includes: forming a first electrode layer to connect one of a pair of external electrodes on a surface of one side in the thickness direction of the second solid electrolyte layer, respectively, for multiple unit battery cells; forming a first side protective layer to cover a side surface of the first electrode layer on one side surface in the thickness direction of the second solid electrolyte layer; forming the second electrode layer alternately with the first electrode layer and to connect the other surface of the pair of external electrodes at other surface of the thickness direction of the second solid electrolyte layer; forming a second side protective layer on a surface of the other side in the thickness direction of the second solid electrolyte layer to cover a side surface of the second electrode layer.

### Effects of Invention

The multi-layer ceramic battery (MLCB) and the method for manufacturing the same according to the present invention has an advantage of preventing moisture from penetrating into the active material electrode layer due to thermal shock and the like by forming a side protective layer along the active material electrode layer of a unit battery cell, thereby improving moisture permeation prevention.

The present invention also has the advantage of forming a side protective layer using LAS-based ceramic and glass frit, reducing thermal expansion rate to stable high temperature characteristics, and improving moisture resistance to further improve moisture permeability prevention.

Further, the present invention forms a side protective layer larger than the surface area of a unit battery cell to increase adhesive force to a cathode layer or an anode layer during sintering, thereby improving sealing characteristics and preventing moisture permeation.

### BRIEF DESCRIPTION OF DRAWINGS

FIG. 1 is a flow chart showing a method for manufacturing a multi-layer ceramic battery (MLCB) according to the present invention.

FIG. 2 is a perspective view of an MLCB manufactured by the manufacturing method for MLCB as shown in FIG. 1.

FIG. 3 is a cross-sectional view of line A-A shown in FIG. 2.

FIG. 4 is a cross-sectional view of line B-B shown in FIG. 2.

FIG. 5 is a perspective view of the first and second solid electrolyte layers shown in FIG. 3.

FIG. 6 is a perspective view of the first electrode layer shown in FIG. 3.

FIG. 7 is a perspective view of the first side protective layer shown in FIG. 3.

FIG. 8 is a perspective view of the second electrode layer illustrated in FIG. 3.

FIG. 9 is a perspective view of a second electrode layer formed on the second side protective layer shown in FIG. 8.

FIG. 10 is an exploded view of the laminate shown in FIG. 3.

FIG. 11 is an assembly view illustrating an assembled state of a laminated body shown in FIG. 10.

FIG. 12 is a perspective view illustrating a state in which an intermediate protective layer is formed on the laminated body shown in FIG. 10.

FIG. 13 is a perspective view illustrating a state in which an outer protective layer is formed on the laminated body shown in FIG. 10.

### DETAILED DESCRIPTION OF THE EMBODIMENTS

Hereinafter, a description will be given as to embodiments of a multi-layer ceramic battery (MLCB) and a method for manufacturing the same according to the present invention with reference to the accompanying drawings.

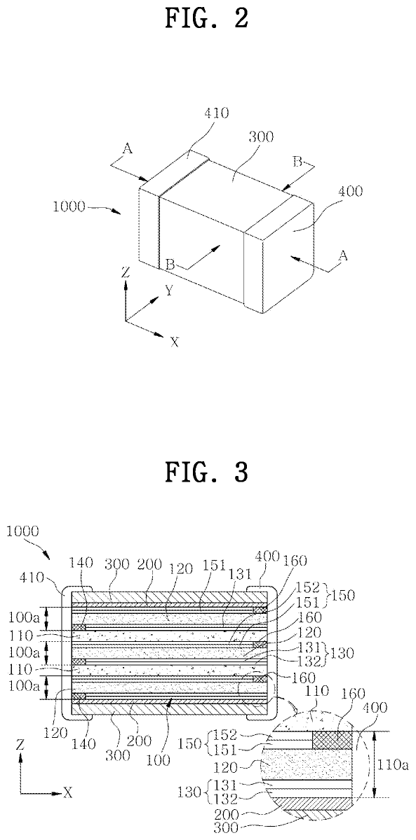

A multi-layer ceramic battery (MLCB) of the present invention includes a laminated body 100, an intermediate protective layer 200, an outer protective layer 300, and a pair of external electrodes 400 and 410, as shown in FIGS. 2 to 4.

The laminated body 100 is formed by laminating multiple unit battery cells 100a after interposing a first solid electrolyte layer 110 therebetween, and the intermediate protective layer 200 is formed to expose an end surface of one side or the other side of the laminated body 100 and cover a surface of the laminated body 100.

The outer protective layer 300 is formed so that the end surface of one side or the other side of the longitudinal direction (X) of the laminated body 100 is exposed and the surface of the intermediate protective layer 200 is covered.

The pair of external electrodes 400 and 410 partially surrounds one side or the other side of the longitudinal direction (X) of the laminated body 100 and is connected to each end surface, when the external protective layer 300 is formed.

Each of the unit battery cells 100a includes a second solid electrolyte layer 120, a first electrode layer 130, a first side protective layer 140, a second electrode layer 150, and a second side protective layer 160.

The first electrode layer 130 is formed on a surface on one side in the thickness direction (Z) of the second solid electrolyte layer 120 to be connected to one of the pair of external electrodes 400 and 410. The first side protective layer 140 is formed to cover a side surface of the first electrode layer 130 on one side surface in the thickness direction Z of the second solid electrolyte layer 120. The second electrode layer 150 is connected to another of the pair of external electrodes 400 and 410 on the surface of the other side in the thickness direction Z of the second solid electrolyte layer 120 and is formed to alternate with the first electrode layer 130. The second side protective layer 160 is formed to cover a side surface of the second electrode layer 150 on the other side of the thickness direction Z of the second solid electrolyte layer 120.

The method for manufacturing a multi-layer ceramic battery (MLCB) of the present invention with such a configuration includes forming a laminated body 100 by laminating a first solid electrolyte layer 110 interposed between a plurality of unit battery cells 100a, respectively, in step S100. After the laminated body 100 is formed, an intermediate protective layer 200 is formed to cover a surface of the laminated body 100 and to exposed an end section of one side or the other side in the longitudinal direction (X) of the laminated body 100, in step S200. After the intermediate protective layer 200 is formed, an outer protective layer 300 is formed to cover a surface of the intermediate protective layer 200 and to expose the end section of one side or the other side in the longitudinal direction (X) of the laminated body 100, in step S300. After the outer protective layer 300 is formed, a pair of external electrodes 400, 410 is formed to connect each end surface of the laminated body 100, respectively and to partially surround one side or the other side in the longitudinal direction (X) of the laminated body 100, in step S400.

The step S100 of forming the laminated body 100 includes forming a first electrode layer 130 to connect one of a pair of external electrodes 400,410 on a surface of one side in the thickness direction (Z) of the second solid electrolyte layer, respectively, for multiple unit battery cells 100a, in step S110. After the first electrode layer 130 is formed, a first side protective layer 140 is formed to cover a side surface of the first electrode layer 130 on one side surface in the thickness direction (Z) of the second solid electrolyte layer 120, in step S120. After the first side protective layer 140 is formed, a second electrode layer 150 is formed alternately with the first electrode layer 130 and to connect the other surface of the pair of external electrodes 400,410 at other surface of the thickness direction (Z) of the second solid electrolyte layer 120, in step S130. After the second electrode layer 150 is formed, a second side protective layer 160 is formed on a surface of the other side in the thickness direction (Z) of the second solid electrolyte layer 120 to cover a side surface of the second electrode layer 150, in step S140.

An embodiment of the method for manufacturing a multi-layer ceramic battery (MLCB) according to the present invention is described as follows.

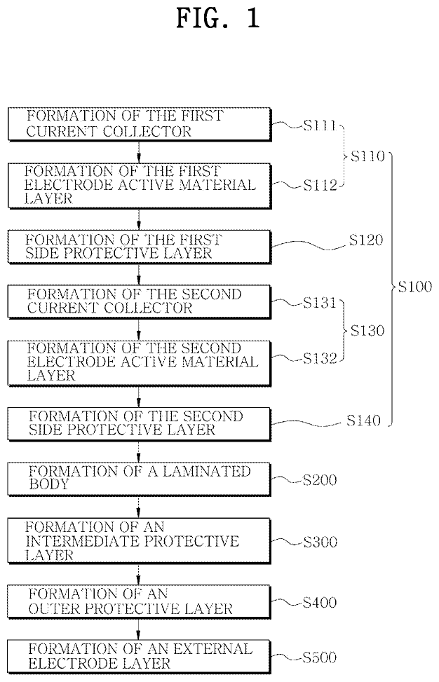

The method for manufacturing an MLCB 1000 according to the present invention forms a plurality of unit battery cells 100a. As shown in FIGS. 1, 5, and 6, each of the unit battery cells 100a forms a first electrode layer 130 to be connected to one of the pair of external electrodes 400 and 410 on a surface of one side in the thickness direction (Z) of the second solid electrolyte layer 120, in step S110.

The step S110 of forming the first electrode layer 130 includes a step S111 of forming the first current collector layer 131 and a step S112 of forming the first electrode active material layer 132.

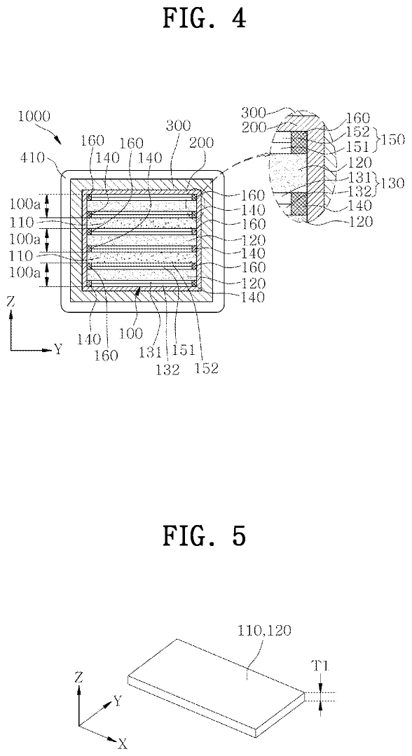

In the step S110 forming a first electrode layer 130, the first current collector layer 131 is aligned at one end of one side in the longitudinal direction (X) of the second solid electrolyte layer 120 to be connected to one of the pair of external electrodes 400 and 410 and is formed to be spaced apart from the edge on one side of the thickness direction (Z) of the second solid electrolyte layer 120, in step S111. Specifically, as shown in FIGS. 3 and 4, the first current collector layer 131 is arranged at one end of the longitudinal (X) of the second solid electrolyte layer 120 to be electrically connected to the external electrode 400 of one of the pair of external electrodes 400 and 410, and is formed at the thickness direction (Z) of the second solid electrolyte layer 120 at the other end except for the end of one side, that is, in a state of being spaced apart from the edge by a predetermined interval.

The first current collector layer 131 is formed in a sheet shape and then formed by laminating the sheet-shaped first current collector layer 131 on the surface of the second solid electrolyte layer 120. The first current collector layer 131 is also formed by coating the surface of the second solid electrolyte layer 120 using a printing method such as silk printing or ink printing. The material of the first current collector layer 131 is formed by mixing one or both of metal and carbon. The metal is formed by mixing at least one selected from silver (Ag), palladium (Pd), gold (Au), platinum (Pt), copper (Cu), nickel (Ni), aluminum (Al), and stainless steel, and the carbon is formed by mixing at least one of graphite, carbon fiber, carbon black, and carbon nanotube.

After the first current collector layer 131 is formed, the first electrode active material layer 132 is formed on a surface of one side in the thickness direction (Z) of the first current collector layer 131, in step S112. The first electrode active material layer 132 is formed to have the same surface area as that of the first current collector layer 131. The formation method of the first electrode active material layer 132 is formed by forming a sheet shape and then laminating the sheet-shaped first electrode active material layer 132 on the surface of the first current collector layer 131. The first current collector layer 131 is also formed by coating the surface of the first current collector layer 131 using a printing method such as silk printing or ink printing. As for the material of the first electrode active material layer 132, a cathode active material is used if the material of the second electrode active material layer 152 is an anode active material, and an anode active material is used if the material of the second electrode active material layer 152 is a cathode active material.

The cathode active material is formed by mixing main composition, a binder, and a conductive additive.

The main composition is used one of LCO (LiCoO2), NCM (LiNiCoMnO2), LFP (LiFePO4), LMO (LiMn2O4), LNMO (LiNi0.5Mn1.5O4), and LNO (LiNiO2). The binder includes an organic binder and an oxide-based solid electrolyte, the organic binder is used at least one selected from polyvinyl butyral, dioctyl phthalate, dibutyl phthalate, phosphate ester, and toluene, the oxide-based solid electrolyte is used at least one selected from Li-based glass, LLZO (Li7La3Zr2O12, 0<x<0.16) and NASICON (Li1+xAlxTi2-x(PO4)3, x=0, 0.3, 0.5) and the conductive additive is used at least one selected from aluminum (Al), zinc (Zn), gold (Au), palladium (Pd), platinum (Pt), tin (Sn) and silver (Ag). The anode active material is used at least one selected from LTO (Li4Ti5O12), carbon, graphene, and carbon nanotubes.

After the first electrode layer 130 (i.e., when the first current collector layer 131 and the first electrode active material layer 132 are continuously formed), is formed, as shown in FIGS. 1 and 7, a first side protective layer 140 is formed on one surface in the thickness direction (Z) of the second solid electrolyte layer 120 to cover the side surface of the first electrode layer 130, in step S120. The first side protective layer 140 is formed to cover each side surface of the first current collector layer 131 and the first electrode active material layer 132 on one side surface in the thickness direction (Z) of the second solid electrolyte layer 120.

The first side protective layer 140 is formed by printing a surface area larger than a surface area of the second solid electrolyte layer 120. The thickness T4 of first side protective layer 140 is equal to the sum T2+T3 of the thickness T2 of the first current collector layer 131 and the thickness T3 of the first electrode active material layer 132 as shown in FIGS. 5 to 7. Here, the thickness (T2) of the first current collector layer 131 is formed by printing on the surface of the second solid electrolyte layer 120 or by laminating it with a sheet so that it is 10 to 30 μm. Also, the thickness (T3) of the first electrode active material layer 132 is formed by printing on the surface of the first current collector layer 131 or the second current collector layer 151 or laminated with a sheet so that it is 10 to 30 μm.

The material of the first side protective layer 140 is formed of the same material as that of the second side protective layer 160. Each of the first side protective layer 140 and the second side protective layer 160 is formed of a glass material, and more specifically, 10 to 70% by weight of LAS(LiO₂—Al₂O₃—SiO₂) glass and 30 to 90% by weight of SVP (Sb(Antimony)-V(Vanadium)-P(Phosphorus) glass. The LAS glass(LAS-based glass) is used by mixing 20 to 28% by weight of LiO₂, 20 to 28% by weight of Al₂O₃, and 44 to 60% by weight of SiO₂ to form powder with an average particle diameter (D₅₀) of 1 to 5 μm. Also, SVP glass is formed as a powder with an average particle diameter (D₅₀) of 1 to 10 μm by mixing 15 to 26% by weight of Sb₂O₃, 45 to 58% by weight of V₂O₅, 25 to 27% by weight of P₂O₅, 1.0% by weight of TiO₂, and 1.0% by weight of Al₂O₃.

After the first side protective layer 140 is formed, as shown in FIGS. 1 and 8, in a state where the surface of the second solid electrolyte layer 120 on which the first electrode layer 130 is formed is inverted, a second electrode layer 150 is formed alternately with the first electrode layer 130 and is connected to another one of the pair of external electrodes 400 and 410 on the other side of the thickness direction (Z) of the second solid electrolyte layer 120, in step S130.

The second electrode layer 150 is aligned at an end of the other side of the longitudinal direction (X) of the second solid electrolyte layer 120 and connected to the other one of the pair of external electrodes 400, 410, the second current collector layer 151 is spaced apart from the edge on the surface of the other side of the thickness direction (Z) of the second solid electrolyte layer 120 and is formed to alternate with the first electrode layer 130, in step S131.

The second current collector layer 151 is aligned at an end of the other side of the longitudinal direction (X) of the second solid electrolyte layer 120 so as to be electrically connected to the other external electrode 410 of the pair of external electrodes 400 and 410, and is formed at the other end except for the other end, that is, on the surface of the other side of the thickness direction (Z) of the second solid electrolyte layer 120 while being spaced apart from the edge at regular intervals. A manufacturing method or material of the second current collector layer 151 is the same as that of the first current collector layer 131, and thus a description thereof will be omitted.

After the second current collector layer 151 is formed, a second electrode active material layer 152 is formed on a surface on the other side of the thickness direction (Z) of the second current collector layer 151, in step S132. The second electrode active material layer 152 is formed on the second current collector layer 151 in the same manner as the first electrode active material layer 132. The second electrode active material layer 152 is used as a cathode active material if the material of the first electrode active material layer 132 is an anode active material, and is used as an anode active material if the material of the first electrode active material layer 132 is a cathode active material. A method and a material of manufacturing the second electrode active material layer 152 are the same as those of the first electrode active material layer 132, and thus a description thereof will be omitted.

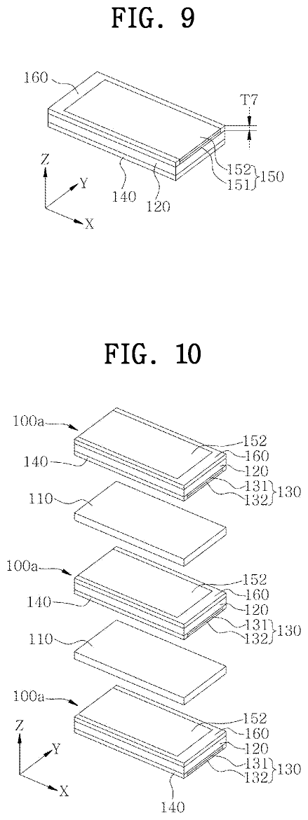

After continuously forming the second current collector layer 151 and the second electrode active material layer 152, the second electrode layer 150 including the second current collector layer 151 and the second electrode active material layer 152 is formed. As shown in FIGS. 1 and 9, the second side protective layer 160 is formed to cover the side surface of the second electrode layer 150 on the other side of the thickness direction Z of the second solid electrolyte layer 120, in step S140.

The second side protective layer 160 is formed to cover each side of the second current collector layer 151 and the second electrode active material layer 152 on the other side of the thickness direction (Z) of the second solid electrolyte layer 120. The second side protective layer 160 is formed using silk printing to have a thickness (T7: shown in FIG. 9) equal to the sum (T5+T6) of the thickness (T5: shown in FIG. 8) of the second current collector layer 151 and the thickness (T6: shown in FIG. 8) of the second electrode active material layer 152. Here, the thickness (T5) of the second current collector layer 151 is formed by printing on the surface of the second solid electrolyte layer 120 or by laminating it as a sheet so that it is 10 to 30 μm. Also, the thickness (T6) of the second electrode active material layer 152 is formed by printing on the surface of the first current collector layer 131 or the second current collector layer 151 or laminated with a sheet so that it is 10 to 30 μm.

Each material of the first side protective layer 140 and the second side protective layer 160 is formed by mixing 10 to 70% by weight of LAS glass and 30 to 90% by weight of SVP glass. The LAS glass is used by mixing LiO₂ 20 to 28% by weight, Al₂O₃ 20 to 28% by weight, and SiO₂ 44 to 60% by weight to form powder with an average particle diameter (D₅₀) of 1 to 5 μm. The SVP glass is formed as a powder with an average particle diameter (D₅₀) of 1 to 10 μm by mixing 15 to 26% by weight of Sb₂O₃, 45 to 58% by weight of V₂O₅, 25 to 27% by weight of P₂O₅, 1.0% by weight of TiO₂, and 1.0% by weight of Al₂O₃.

The first solid electrolyte layer 110 and the second solid electrolyte layer 120 are formed to have the same surface area using an oxide-based solid electrolyte, respectively, and are formed in the form of a sheet or using a printing method such as silk printing or ink printing.

The oxide-based solid electrolyte used in the first solid electrolyte layer 110 and the second solid electrolyte layer 120 includes one of Li-based glass, LLZO (Li₇La₃Zr₂O₁₂, 0<x<0.16) and NASICON (Li₁₊ₓAlₓTi₂₋ₓ(PO₄)₃, x=0, 0.3, 0.5. The Li-based glass includes 54 to 60 wt % of Li, 10 to 17 wt % of Si, and 13 to 17 wt % of B₂O₃. The first solid electrolyte layer 110 and the second solid electrolyte layer 120 are provided by forming a printing method or as a sheet such that the thickness (T1; (T1: as shown in FIG. 5)) is 10 to 30 μm using an oxide-based solid electrolyte having an ion conductivity of 10⁻³ to 10⁻⁴ S/cm, respectively.

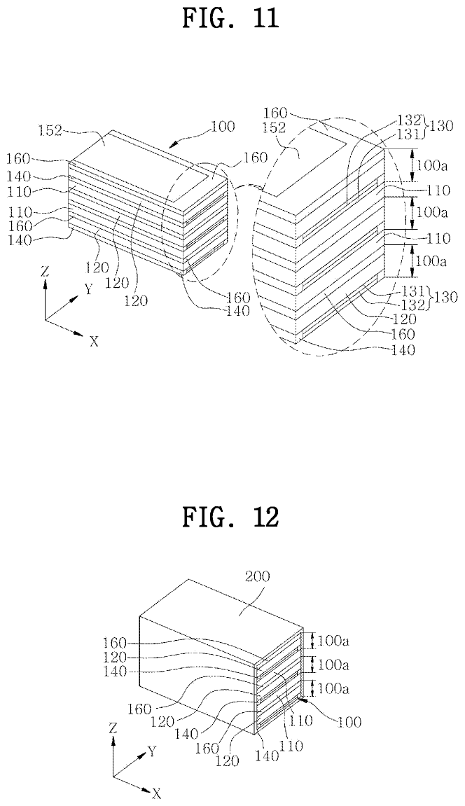

After multiple unit battery cells 100a are formed through the aforementioned process (see FIG. 10), the first solid electrolyte layer 110 is inserted, laminated, compressed, and thermally treated between multiple unit battery cells 100a to form a laminate 100 in the shape of a rectangular parallelepiped chip as shown in FIG. 11. Here, the first solid electrolyte layer 110 is disposed and laminated between the unit battery cells 100a, respectively.

After a laminated body 100 is formed, as shown in FIGS. 3, 4, and 12, one end surface or the other end surface of the laminated body 100 is exposed, and an intermediate protective layer 200 is formed so that the surface of the laminate 100 is covered, in step S200. The intermediate protective layer 200 is formed to have a thickness of 10 to 20 μm by mixing an oxide-based solid electrolyte and a ceramic material.

After the intermediate protective layer 200 is formed, as shown in FIGS. 3, 4, and 13, the outer protective layer 300 is formed to cover the surface of the intermediate protective layer 200 by exposing the end surface of one side or the other side in the longitudinal direction (X) of the laminated body 100, in step S300.

In the step of forming the outer protective layer 300, the outer protective layer 300 is formed to have a thickness of 10 to 50 μm using ceramic materials, and one of Al₂O₃, SiO₂, SiN, AlN, and SiC is used as the ceramic material.

After the external protective layer 300 is formed, as shown in FIG. 2, a pair of external electrodes 400 and 410 are formed to partially surround one side or the other side of the longitudinal direction (X) of the laminated body 100 and be connected to each end surface, in step S400. Here, in the step of forming a pair of external electrodes 400 and 410, a pair of external electrodes 400 and 410 are formed by sequentially plating or dipping Cu, Ni, and Sn, respectively, so that the MLCB (1000) manufactured in this invention is made of SMD(Surface Mounting Device) MLCB.

First, to manufacture the MLCB 1000 of this invention, as shown in FIGS. 1,5 and 9, the first solid electrolyte layer 110 and the second solid electrolyte layer 120 are manufactured. Each of the first solid electrolyte layer 110 and the second solid electrolyte layer 120 forms an oxide-based solid electrolyte in a plate shape with a thickness (T1) of 20 μm using a silk printing method, and Li-based glass was formed including 60% by weight of Li, 10% by weight of Si, and 13% by weight of B₂O₃.

After forming the first solid electrolyte layer 110 and the second solid electrolyte layer 120, as illustrated in FIGS. 1, 6, and 7, a first electrode layer 130 and a first side protective layer 140 including the first current collector layer 131 and the first electrode active material layer 132 were continuously formed. After the first electrode layer 130 is formed, as shown in FIGS. 1 and 8, the second solid electrolyte layer 120 is inverted so that the second solid electrolyte layer 120 faces the lower side of the thickness direction Z. In addition, a second electrode layer 150 including the second current collector layer 151 and the second electrode active material layer 152 and a second side protective layer 160 were continuously formed.

In the first electrode layer 130, the first current collector layer 131 and the first electrode active material layer 132 overlap each other on the surface of the second solid electrolyte layer 120. In addition, the second electrode layer 150 is formed by overlapping the second current collector layer 151 and the second electrode active material layer 152 on the surface of the second solid electrolyte layer 120. The first electrode layer 130 and the second electrode layer 150 were formed alternately on one side and the other side in the thickness direction (Z) of the second solid electrolyte layer 120, respectively.

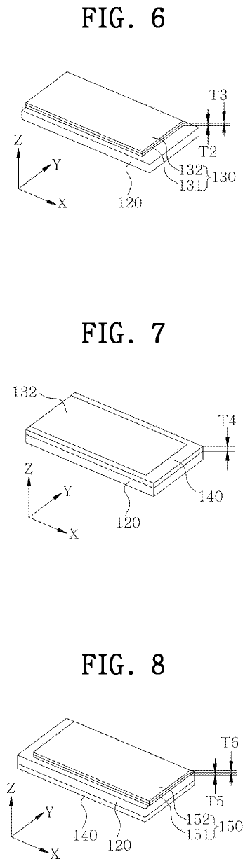

The first current collector layer 131 and the second current collector layer 151 of the first electrode layer 130 and the second electrode layer 150 form Cu or Al containing carbon black to have a thickness (T2, T5) of 20 μm using a printing method as shown in FIGS. 6 and 8. In addition, the first electrode active material layer 132 and the second electrode active material layer 152 formed anode active material and cathode active material to have a thickness (T3, T6) of 20 μm using a printing method. The first electrode layer 130 and the second electrode layer 150 are formed to have thicknesses T2+T3 and T5+T6 of 40 μm, respectively.

After forming the first electrode layer 130 or the second electrode layer 150, a first side protective layer 140 or a second side protective layer 160 is formed as shown in FIGS. 1, 7, and 9. The first side protective layer 140 and the second side protective layer 160 are made of the same material using a printing method so that their thickness (T4, T7) is 40 μm equal to the thickness of the first electrode layer 130 or the second electrode layer 150. The material of the first side protective layer 140 and the second side protective layer 160 was formed by mixing 70% by weight of LAS glass and 30% by weight of SVP glass. The LAS glass was used by mixing 28% by weight of LiO₂, 20% by weight of Al₂O₃, and 44% by weight of SiO₂ to form a powder having an average particle diameter (D₅₀) of 13 μm. In addition, the SVP glass was used by mixing 26% by weight of Sb₂O₃, 45% by weight of V₂O₅, 25% by weight of P₂O₅, 1.0% by weight of TiO₂, and 1.0% by weight of Al₂O₃ to form a powder with an average particle diameter (D₅₀) of 1 to 10 μm.

The first side protective layer 140 and the second side protective layer 160 is used by mixing LAS glass and SVP glass, respectively, so that the glass transition temperature (Tg) is 450 to 1100° C. depending on the mixing ratio. This is because SVP glass has an excellent moisture-proof effect as a sealing material, but damage can occur due to high temperatures in a process that requires heat of 470° C. or higher due to a low melting point of 330 to 451° C. Thus, LAS glass with a glass transition temperature (Tg) of 1250 to 1350° C. was mixed and used as β-eucryptite (LiAlSiO₄ (LAS)). The first side protective layer 140 or the second side protective layer 160 uses a mixture of LAS glass and SVP glass, respectively, to reduce the thermal expansion rate, improving the resistance of ceramic to thermal shock under circulation conditions between high temperature and room temperature. As a result, the MLCB 1000 of this invention can further improve moisture permeation prevention by improving sealing characteristics.

A plurality of unit battery cells 100a having a first side protective layer 140 and a second side protective layer 160 formed on one side and the other side of the thickness direction (Z) of the second solid electrolyte layer 120 are formed, and then a laminated body 100 is formed. As shown in FIG. 10, the laminated body 100 was formed by inserting a first solid electrolyte layer 110 between a plurality of unit battery cells 100a, laminating, compressing, and heat-treating the same as shown in FIG. 11. Descriptions of lamination, compression, and heat treatment will be omitted by applying known techniques, respectively.

After forming the laminated body 100, as shown in FIGS. 1 and 12, the intermediate protective layer 200 was formed to have a thickness of 150 μm by mixing an oxide-based solid electrolyte and a ceramic material so that the surface of the laminated body 100 was covered. Among the materials of the intermediate protective layer 200, the solid electrolyte is made of the same material as the first solid electrolyte layer 110 and the second solid electrolyte layer 120. In addition, the ceramic material was the same material as the ceramic material used in the external protective layer 300, and the mixing ratio was formed by mixing 55% by weight of the solid electrolyte and 45% by weight of the ceramic material.

As described above, the intermediate protective layer 200 is used by mixing a solid electrolyte and a ceramic material, thereby preventing the inflow of foreign materials such as moisture penetrating from the outside even when the first electrode active material layer 132 and the second electrode active material layer 152 are disposed at the top and the bottom of MLCB 1000 of this invention. In other words, the intermediate protective layer 200 prevents internal resistance from increasing by blocking and preventing an irreversible reaction between the first solid electrolyte layer 110 and the second solid electrolyte layer 120.

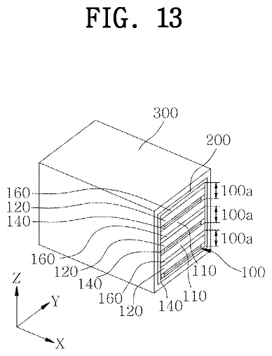

After forming the intermediate protective layer 200, as shown in FIGS. 1 and 13, the outer protective layer 300 was formed to have a thickness of 30 μm using ceramic material to cover the surface of the intermediate protective layer 200, and Al₂O₃ was used as the ceramic material. The outer protective layer 300 was formed using an average particle diameter (D₅₀) of 10 μm to improve the productivity of the manufacturing work and prevent foreign substances or moisture from penetrating into the laminated body 100.

After the external protective layer 300 is formed, as shown in FIGS. 1, 2, 3, and 4, a pair of external electrodes 400 and 410 are partially surrounded by one side or the other side of the laminated body 100 and connected to each end surface. Cu, Ni, and Sn are sequentially plated on a pair of external electrodes 400 and 410, respectively, to manufacture the MLCB 1000 of this invention.

The MLCB 1000 of this invention manufactured as described above is manufactured in the form of surface mount devices (SMD) as shown in FIGS. 2, 3, and 4. That is, the above MLCB 1000 is manufactured in surface-mount technology chip size such as 1005, 1608, 2012, 3216, 3225, 4520, and 5750 and is used as a power source for small electronic devices (not shown) such as the Internet of Things (IoT), wearable devices, or sensors. The SMT chip size of the MLCB 1000 is set to the same standard as the SMT chip size of the known chip capacitor (not shown). In addition, the MLCB 1000 of this invention has a multi-layer structure by laminating and manufacturing multiple unit battery cells 100a that act as batteries, and includes ceramic materials in the first side protective layer 140, the second side protective layer 160, the middle protective layer 200, and the outer protective layer 300, respectively.

As described above, the MLCB and its manufacturing method of the present invention form a side protective layer along the active material electrode layer of the unit battery cell to prevent moisture from penetrating the active material electrode layer due to thermal shock. In addition, this invention can reduce the thermal expansion rate with stable high-temperature properties by forming a side protective layer using LAS ceramic and glass frit, or SVP glass, and improve sealing properties to improve moisture resistance and further improve moisture permeation prevention. Furthermore, in this invention, the side protective layer is formed larger than the surface part of the unit battery cell to increase adhesive force to the cathode layer or the anode layer during sintering, thereby improving sealing characteristics and preventing moisture permeation.

### INDUSTRIAL AVAILABILITY

The multi-layer ceramic battery (MLCB) and the method for manufacturing the same according to the present invention are applied to the field of solid state battery manufacturing industry.

What is claimed is:

1. A method for manufacturing a multi-layer ceramic battery (MLCB), comprising:
forming a laminated body by laminating a first solid electrolyte layer interposed between a plurality of unit battery cells, respectively;
forming an intermediate protective layer to cover a surface of the laminated body and to expose an end section of one side or the other side in the longitudinal direction of the laminated body;
forming an outer protective layer to cover a surface of the intermediate protective layer and to expose the end section of one side or the other side in the longitudinal direction of the laminated body; and
forming a pair of external electrodes to connect each end surface of the laminated body, respectively and to partially surround one side or the other side in the longitudinal direction of the laminated body;
wherein the step of forming the laminated body comprises:
forming a first electrode layer to connect one of a pair of external electrodes on a surface of one side in the thickness direction of the second solid electrolyte layer, respectively, for multiple unit battery cells;
forming a first side protective layer to cover a side surface of the first electrode layer on one side surface in the thickness direction of the second solid electrolyte layer;
forming a second electrode layer alternately with the first electrode layer and to connect the other surface of the pair of external electrodes at other surface of the thickness direction of the second solid electrolyte layer;
forming a second side protective layer on a surface of the other side in the thickness direction of the second solid electrolyte layer to cover a side surface of the second electrode layer.

2. The method according to claim 1, wherein the step of forming a first electrode layer, comprises:
forming a first current collector layer to be spaced apart from the edge on a surface on one side in the thickness direction of the second solid electrolyte layer, and to align at an end of one side in the longitudinal direction of the second solid electrolyte layer and to connect one of a pair of external electrodes; and
forming a first electrode active material layer on a surface of one side in the thickness direction of the first current collector layer
wherein the step of forming a second electrode layer, comprises:
forming a second current collector layer to be spaced apart from an edge on a surface on the other side in the thickness direction of the second solid electrolyte layer so as to alternate with the first electrode layer, and to align at an end of the other side in the longitudinal direction of the second solid electrolyte layer and to connect the other side of a pair of external electrodes; and
forming a second electrode active material layer on the surface of the other side in the thickness direction of the second current collector layer.

3. The method according to claim 2, wherein the first and second current collectors are formed by mixing one or more of metal and carbon, respectively, and the metal is formed by mixing at least one selected from silver (Ag), palladium (Pd), gold (Au), platinum (Pt), copper (Cu), nickel (Ni), aluminum (Al), and stainless steel, and the carbon is formed by mixing at least one of graphite, carbon fiber, carbon black, and carbon nanotube,
wherein materials of the first and second electrode active material layers are used of active materials of different poles, the material of the cathode active material is formed by mixing main composition, binder, and conductive additive agents, the main composition is one of LCO (LiCoO₂), NCM (LiNiCoMnO₂), LFP (LiFePO₄), LMO (LiMn2O₄), LNMO (LiNi_{0.5}Mn_{1.5}O₄), and LNO (LiNiO₂), wherein the binder includes an organic binder and an oxide-based solid electrolyte, the organic binder is used at least one selected from polyvinyl butyral, dioctyl phthalate, dibutyl phthalate, phosphate ester, and toluene, the oxide-based solid electrolyte is used at least one selected from Li-based glass, LLZO (Li₇La₃Zr₂O₁₂, 0<x<0.16) and NASICON (Li₁₊ₓAlₓTi₂₋ₓ(PO₄)₃, x=0, 0.3, 0.5) and the conductive additive is used at least one selected from aluminum (Al), zinc (Zn), gold (Au), palladium (Pd), platinum (Pt), tin (Sn) and silver (Ag), the anode active material is used at least one selected from LTO (Li4Ti5O12), carbon, graphene, and carbon nanotubes.

4. The method according to claim 1, wherein in the step of forming a first side protective layer, the first side protective layer is formed to cover side surfaces of each of the first current collector layer and the first electrode active material layer on one side surface of the second solid electrolyte layer in the thickness direction,
wherein in the step of forming a second side protective layer, the second side protective layer is formed to cover side surfaces of each of the second current collector layer and the second electrode active material layer on a surface of the other side in the thickness direction of the second solid electrolyte layer.

5. The method according to claim 1, wherein in the step of forming a first side protective layer, the first side protective layer is formed by printing with a surface area larger than that of the second solid electrolyte layer, and has a thickness equal to the sum of the thickness of the first current collector layer and the thickness of the first electrode active material layer,
wherein in the step of forming a second side protective layer, the second side protective layer is formed by printing with a surface area larger than that of the second solid electrolyte layer, and the thickness is equal to the sum of the thickness of the second current collector layer and the thickness of the second electrode active material layer.

6. The method according to claim 1, wherein the first and second side protective layers is formed of a glass material, each of the intermediate protective layers is formed by mixing an oxide-based solid electrolyte and a ceramic material, and the outer protective layer is formed of a ceramic material.

7. The method according to claim 1, wherein in the step of forming the first and second side protective layers, each material of the first side protective layer and the second side protective layer is formed by mixing 10 to 70% by weight of LAS glass and 30 to 90% by weight of SVP glass, the LAS glass is used by mixing LiO₂ 20 to 28% by weight, Al₂O₃ 20 to 28% by weight, and SiO₂ 44 to 60% by weight to form powder with an average particle diameter (D₅₀) of 1 to 5 μm, the SVP glass is formed as a powder with an average particle diameter (D₅₀) of 1 to 10 μm by mixing 15 to 26% by weight of Sb₂O₃, 45 to 58% by weight of V₂O₅, 25 to 27% by weight of P₂O₅, 1.0% by weight of TiO₂, and 1.0% by weight of Al₂O₃.

8. The method according to claim 1, wherein each of the first and second solid electrolyte layers is formed to have the same surface area using an oxide-based solid electrolyte, the oxide-based solid electrolyte is used one of Li-based glass, LLZO (Li₇La₃Zr₂O₁₂, 0<x<0.16) and NASICON (Li₁₊ₓAlₓTi₂₋ₓ(PO₄)₃, x=0, 0.3, and 0.5), and the Li-based glass includes 54 to 60%, Si to 17% by weight, and B₂O₃ to 13% by weight.

9. The method according to claim 1, wherein in the step of forming a laminated body, the laminated body is formed in the shape of a chip of a rectangular parallelepiped, and the intermediate protective layer is formed by mixing an oxide-based solid electrolyte with a ceramic material,
wherein in the step of forming an outer protective layer, the outer protective layer is formed of ceramic material to have a thickness of 10 to 50 μm,
wherein in the step of forming a pair of external electrodes, the pair of external electrodes are formed by sequentially plating or dipping copper(Cu), nickel(Ni), and tin(Sn), respectively,
the ceramic material is used one of Al₂O₃, SiO₂, SiN, AlN and SiC.

10. The method according to claim 1, wherein the first solid electrolyte layer and the second solid electrolyte layer are formed by a printing method or a sheet type to have a thickness of 10 to 30 μm using an oxide-based solid electrolyte having an ion conductivity of 10⁻³ to 10⁻⁴ S/cm, respectively,
wherein the first current collector layer and the second current collector layer are formed on the surface of the second solid electrolyte layer by a printing method or a sheet type to have a thickness of 10 to 30 μm, respectively,
wherein the first electrode active material layer and the second electrode active material layer are formed by printing method on the surface of the first current collector layer or the second current collector layer, or laminating them in a sheet type, to have a thickness of 10 to 30 μm, respectively.

11. A multi-layer ceramic battery (MLCB), comprising:
a laminated body formed by laminating multiple unit battery cells with a first solid electrolyte layer interposed therebetween;
an intermediate protective layer exposed to the end surface of one side or the other side in the longitudinal direction of the laminated body, and formed to cover a surface of the laminated body;
an outer protective layer exposed to the end surface of one side or the other side in the longitudinal direction of the laminated body, and formed to cover a surface of the intermediate protective layer; and
a pair of external electrodes partially surrounded one side or the other side in the longitudinal direction of the laminated body and connected each end surface of the laminated body,
Each of the multiple unit battery cells including:
a first electrode layer connected to one of the pair of external electrodes on a surface of one side in the thickness direction of the second solid electrolyte layer,
a first side protective layer formed to cover a side surface of the first electrode layer on one side in a thickness direction of the second solid electrolyte layer,
a second electrode layer connected to the other one of the pair of external electrodes on a surface of the other side in the thickness direction of the second solid electrolyte layer and formed to alternate with the first electrode layer,
a second side protective layer formed to cover the side surface of the second electrode layer on a surface of the other side in the thickness direction of the second solid electrolyte layer.
